(19) United States
(12) Patent Application Publication
(10) Pub. No.: US 2018/0046336 A1
(43) Pub. Date: Feb. 15, 2018

(54) Instant Message Processing Method and Apparatus, and Storage Medium

(71) Applicant: Xiaomi Inc., Beijing (CN)

(72) Inventors: Peng ZHANG, Beijing (CN); Yi GUO, Beijing (CN); Dawei XIONG, Beijing (CN)

(73) Assignee: Xiaomi Inc., Beijing (CN)

(21) Appl. No.: 15/798,091

(22) Filed: Oct. 30, 2017

Related U.S. Application Data
(63) Continuation of application No. PCT/CN2016/112973, filed on Dec. 29, 2016.

(30) Foreign Application Priority Data
Dec. 30, 2015 (CN) 201511021146.5

(51) Int. Cl. G06F 3/0482; H04L 12/58

(52) U.S. Cl. CPC G06F 3/0482; H04L 51/04; A63F 13/87

(57) ABSTRACT

The present disclosure relates to an instant message processing method and apparatus, and a storage medium. The method includes: receiving an instant message and determining an instant messenger to which the instant message belongs; and when it is determined that the instant messenger is not an application corresponding to a current interface, arranging and displaying, on a predetermined edge region of the current interface, the instant messenger together with one or more other unprocessed instant messages which do not belong to the application corresponding to the current interface.

### CROSS-REFERENCE TO RELATED APPLICATIONS

This application is a continuation of PCT Application PCT/CN2016/112973 filed on Dec. 29, 2016, which is based on and claims the priority of the Chinese Patent Application No. 201511021146.5, filed on Dec. 30, 2015, which is incorporated herein by reference in its entirety.

### TECHNICAL FIELD

The present disclosure is related to the technical field of communications, and more particularly to an instant message processing method and apparatus, and a storage medium.

### BACKGROUND

In related art, while a terminal is running an application, the terminal will display a new message in a notification bar when another application receives the new message. A user may view the new message received by the other application by pulling down the notification bar and process the new message by clicking to enter an interface of the application corresponding to the new message. For example, when the terminal is running a game application, the terminal may display a message from a social network application in the notification bar for a short time period. The user has to quit the game application if the user wants to review the full message in the social network application.

### SUMMARY

Embodiments of the present disclosure provide an instant message processing method and apparatus, and a storage medium as follows.

According to a first aspect of the disclosure, there is provided a method for processing instant message. The method includes: receiving an instant message and determining an instant messenger to which the instant message belongs; and when it is determined that the instant messenger is not an application corresponding to a current interface, arranging and displaying, on a predetermined edge region of the current interface, the instant messenger together with one or more other unprocessed instant messages which do not belong to the application corresponding to the current interface.

According to a second aspect of the disclosure, there is provided an instant message processing apparatus. The apparatus includes: a processor and a memory storing instructions executable by the processor. The processor is configured to: receive an instant message and determine an instant messenger to which the instant message belongs; and when it is determined that the instant messenger is not an application corresponding to a current interface, arrange and display, on a predetermined edge region of the current interface, the instant messenger together with one or more other unprocessed instant messages which do not belong to the application corresponding to the current interface.

According to a third aspect of the disclosure, there is provided a non-transitory computer-readable storage medium having stored therein instructions that, when executed by a processor of a mobile terminal, cause the mobile terminal to perform acts including: receiving an instant message and determining an instant messenger to which the instant message belongs; when it is determined that the instant messenger is not an application corresponding to a current interface, arranging and displaying, on a predetermined edge region of the current interface, the instant messenger together with one or more other unprocessed instant messages which do not belong to the application corresponding to the current interface.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart of an instant message processing method according to one or more exemplary embodiments.

FIG. 2 is a flowchart of a step S12 in an instant message processing method according to one or more exemplary embodiments.

FIG. 3 is a schematic diagram illustrating a current interface of a terminal displayed during performance of an instant message processing method according to a one or more exemplary embodiments.

FIG. 4 is a flowchart of an instant message processing method according to one or more exemplary embodiments.

FIG. 5 is a schematic diagram illustrating a current interface of a terminal displayed during performance of an instant message processing method according to the one or more exemplary embodiments.

FIG. 6 is a schematic diagram illustrating a current interface of a terminal displayed during performance of an instant message processing method according to the one or more exemplary embodiments.

FIG. 7 is a flowchart of an instant message processing method according to one or more exemplary embodiments.

FIG. 8 is a schematic diagram illustrating a current interface of a terminal displayed during performance of an instant message processing method according to the one or more exemplary embodiments.

FIG. 9 is a schematic diagram illustrating a current interface of a terminal displayed during performance of an instant message processing method according to the one or more exemplary embodiments.

FIG. 10 is a flowchart of a step S12 in an instant message processing method according to one or more exemplary embodiments.

FIG. 11 is a schematic diagram illustrating a current interface of a terminal displayed during performance of an instant message processing method according to a one or more exemplary embodiments.

FIG. 12 is a flowchart of an instant message processing method according to one or more exemplary embodiments.

FIG. 13 is a schematic diagram illustrating a current interface of a terminal displayed during performance of an instant message processing method according to the one or more exemplary embodiments.

FIG. 14 is a schematic diagram illustrating a current interface of a terminal displayed during performance of an instant message processing method according to the one or more exemplary embodiments.

FIG. 15 is a schematic diagram illustrating a current interface of a terminal displayed during performance of an instant message processing method according to the one or more exemplary embodiments.

FIG. 16 is a block diagram of an instant message processing apparatus according to one or more exemplary embodiments.

FIG. 17 is a block diagram of a first displaying module in an instant message processing apparatus according to one or more exemplary embodiments.

FIG. 18 is a block diagram of an instant message processing apparatus according to one or more exemplary embodiments.

FIG. 19 is a block diagram of a first displaying module in an instant message processing apparatus according to one or more exemplary embodiments.

FIG. 20 is a block diagram of an instant message processing apparatus according to one or more exemplary embodiments.

FIG. 21 is a block diagram of an instant message processing apparatus according to one or more exemplary embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

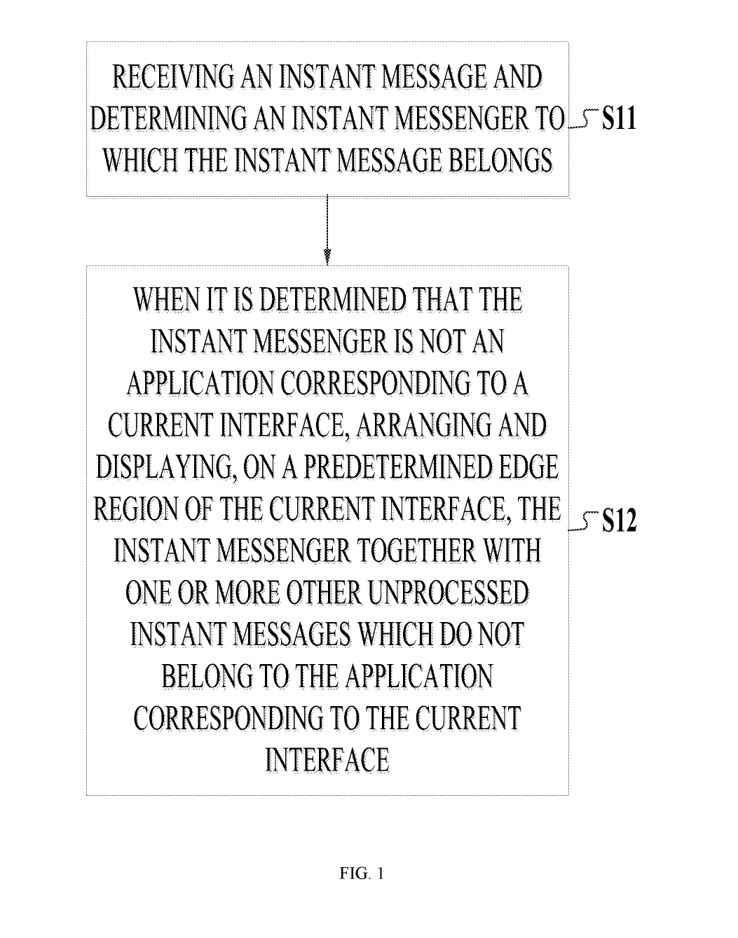

FIG. 1 is a flowchart of an instant message processing method according to one or more exemplary embodiments. The method is used in a terminal, which may be a mobile phone, a computer, a digital broadcast terminal, a messaging device, a gaming console, a tablet device, a medical device, exercise equipment, a personal digital assistant or the like. As shown in FIG. 1, the method comprises the following steps S11-S12.

In step S11, an instant message is received, and an instant messenger to which the instant message belongs is determined.

The instant message is a message communicated by a user using the instant messenger. The instant messenger may include one of a social network messenger, a text message messenger, or any other application that can be used to send messages to the user.

In step S12, when it is determined that the instant messenger is not an application corresponding to a current interface, the instant message is arranged and displayed, on a predetermined edge region of the current interface, together with one or more other unprocessed instant messages which do not belong to the application corresponding to the current interface.

In one or more embodiments, when arranging and displaying the received instant message, on the predetermined edge region of the current interface, together with one or more other unprocessed instant messages which do not belong to the application corresponding to the current interface, the terminal displays a message identification for each of the displayed instant messages. The message identification includes at least one of an application identification of an instant messenger corresponding to the instant message and an identification of a contact sending the instant message. The terminal may display all unprocessed instant messages on the predetermined edge region of the current interface.

The predetermined edge region may be an edge region on one side of the current interface of the terminal, such as a left edge region, a right edge region, an upper edge region or a lower edge region on the current interface of the terminal, so as not to block primary contents displayed on the current interface of the terminal from being seen. When the terminal includes multiple display screens, the predetermine edge region may be set to be on the secondary display such as a curved portion of the screen.

With the technical solution according to the embodiment of the disclosure, after an instant message of an instant messenger other than an application corresponding to a current interface is received, it can be arranged and displayed, on a predetermined edge region of the current interface, together with other unprocessed instant messages of other instant messengers. When the terminal display all other unprocessed instant messages, the method enables a user to view, on the predetermined edge region of the current interface, all unprocessed instant messages of instant messengers other than the application corresponding to the current interface, and enabling a terminal to effectively prompt a user of instant messages of instant messengers while currently displaying another application interface and without affecting current display of the other application interface.

In the above method, depending on different contents contained in a message identification, the message identification is displayed in different manners. Regarding the contents included in a message identification of an instant message, there are at least two following cases. In the first case, the message identification includes an application identification of an instant messenger corresponding to the instant message and the number of unprocessed instant messages received by the instant messenger corresponding to the instant message. In the second case, the message identification includes an identification of a contact sending the instant message and the number of unprocessed instant messages sent by the contact sending the instant message. In the following, it will be described how to display a message identification of an instant message at a terminal for these two cases respectively.

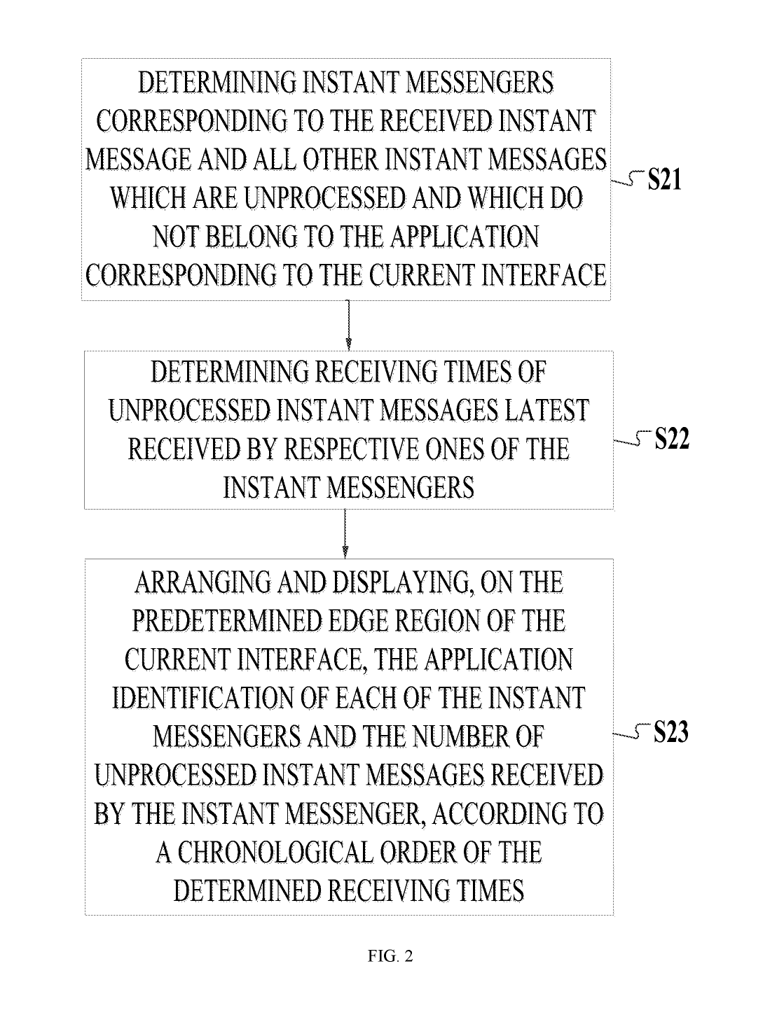

In an embodiment, when the message identification includes the application identification of the instant messenger corresponding to the instant message and the number of unprocessed instant messages received by the instant messenger corresponding to the instant message, the step S12 may be implemented as the following steps S21-S23 as shown in FIG. 2.

At step S21, instant messengers corresponding to the received instant message and all other unprocessed instant messages which do not belong to the application corresponding to the current interface are determined.

At step S22, receiving times of latest unprocessed instant messages received by respective instant messengers are determined.

At step S23, the application identification of each of the instant messengers and the number of unprocessed instant messages received by the instant messenger are arranged and displayed on the predetermined edge region of the current interface, according to a chronological order of the determined receiving times.

As can be seen from the embodiment, when the terminal receives a new instant message which does not belong to the application corresponding to the current interface, it will display the message identification corresponding to the instant message at the very beginning position in the predetermined edge region.

In the disclosure, the terminal arranges and displays, on a predetermined edge region, application identifications of instant messengers and the numbers of unprocessed instant messages received by the instant messengers. Here, message identifications are arranged and displayed according to receiving times of unprocessed instant messages latest received by respective ones of the instant messengers. Thus, the user can know at a glance information on unprocessed instant messages (especially the number of and the chronological order of the receiving times of the unprocessed instant messages) without entering interfaces of instant messengers corresponding to the instant messages, thereby improving user experience.

In the following, the technical solution according to the embodiment will be explained by giving a one or more exemplary embodiments.

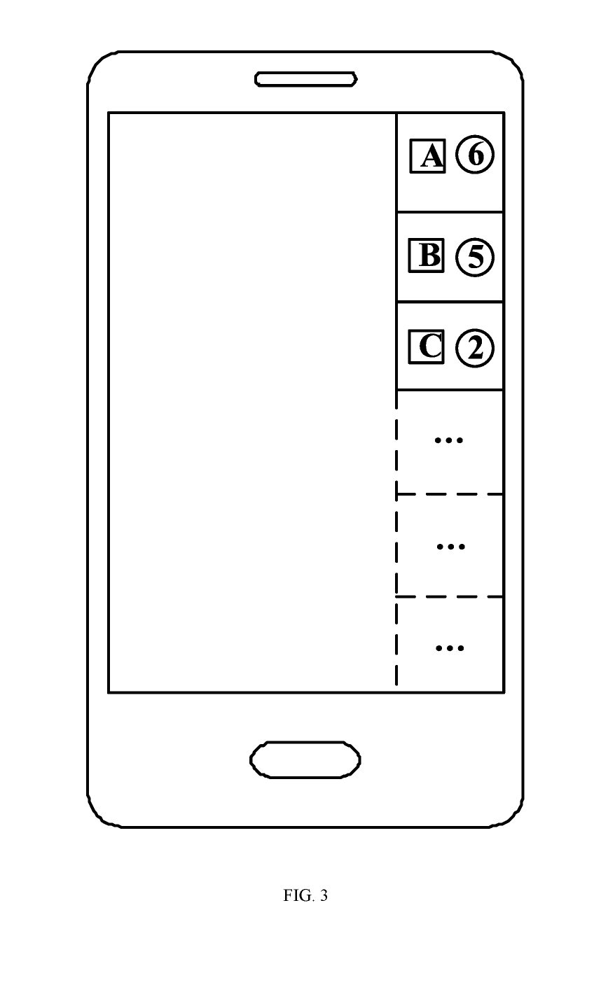

FIG. 3 is a diagram illustrating a current interface of a terminal in the embodiment 1. In this embodiment, the predetermined edge region is a right edge region of the current interface of the terminal. As shown in FIG. 3, the application corresponding to the current interface of the terminal is an application M. On the right edge region of the interface of the terminal, there are arranged and displayed message identifications of unprocessed instant messages received by instant messengers A, B and C. Each message identification includes an application identification of its corresponding instant messenger and the number of unprocessed instant messages received by the instant messenger.

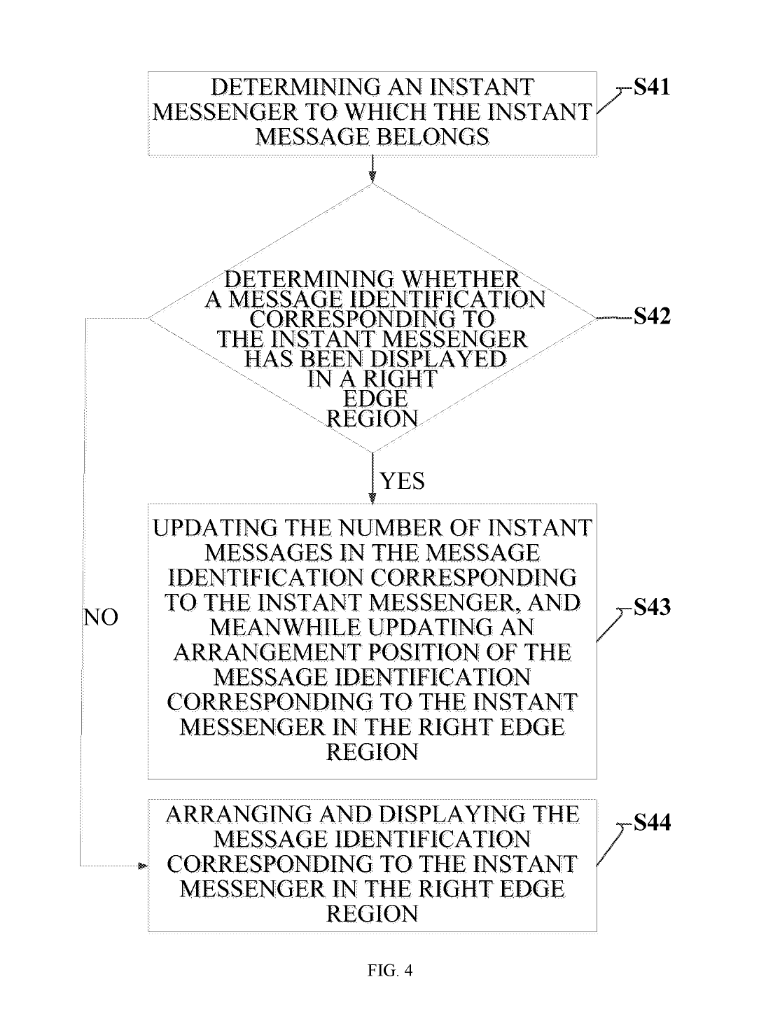

On the terminal interface shown in FIG. 3, the number of unprocessed instant messages received by each instant messenger is shown as a numerical value. Specifically, the number of unprocessed instant messages received by the instant messenger A is 6, the number of unprocessed instant messages received by the instant messenger B is 5, and the number of unprocessed instant messages received by the instant messenger C is 2. When the terminal receives a further instant message which does not belong to the application corresponding to the current interface (namely, the application M), the message identification of the instant message may be arranged and displayed according to the following steps S41-S44 shown in FIG. 4, since the receiving time of the instant message is later than that of any instant message in the right edge region.

At step S41, an instant messenger to which the instant message belongs is determined.

At step S42, it is determined whether a message identification corresponding to the instant messenger has been displayed in the right edge region. The message identification corresponding to the instant messenger is a message identification of one or more unprocessed instant messages received by the instant messenger. If the message identification corresponding to the instant messenger has been displayed in the right edge region, then step S43 is performed. If the message identification corresponding to the instant messenger has not been displayed in the right edge region, step S44 is performed.

At step S43, the number of instant messages in the message identification corresponding to the instant messenger is updated, and meanwhile an arrangement position of the message identification corresponding to the instant messenger in the right edge region is updated.

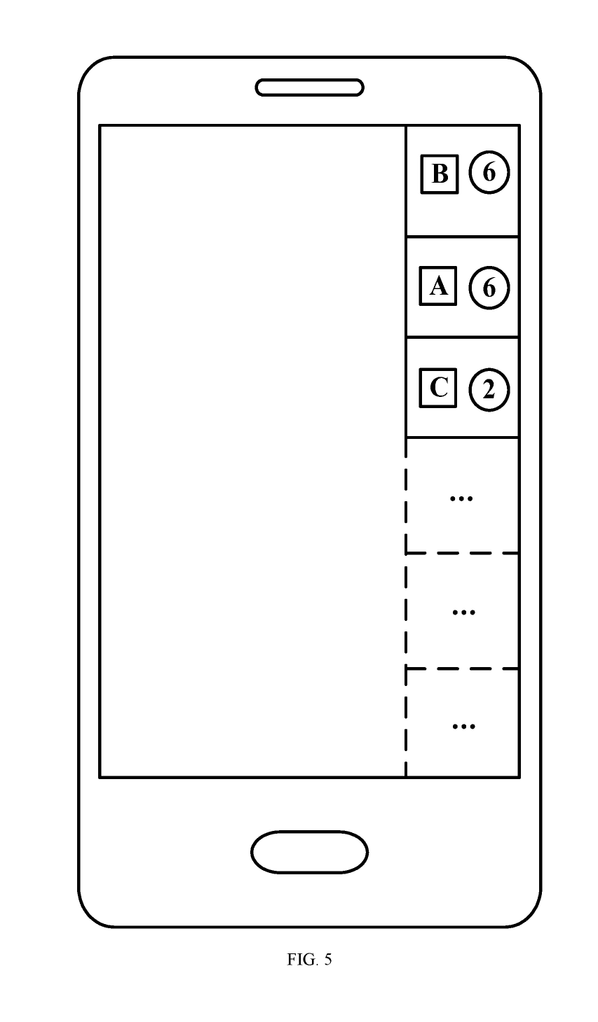

For example, if the instant messenger corresponding to the received instant message is the instant messenger B, then the number in the message identification corresponding to the instant messenger B is updated from 5 to 6. Meanwhile, in the embodiment, message identifications are arranged and displayed in the predetermined edge region according to receiving times of unprocessed instant messages latest received by respective ones of the instant messengers, such that the later the receiving time of an unprocessed instant message latest received by an instant messenger is, the nearer the arrangement position of the message identification corresponding to the instant messenger is to the beginning position in the predetermined edge region. Therefore, the arrangement position of the message identification corresponding to the instant messenger B in the right edge region is updated, that is, the message identification corresponding to the instant messenger B is arranged and displayed at the very beginning position in the right edge region as shown in FIG. 5.

In addition, the message identification of the instant message may also be displayed in a highlighted manner. For example, while being arranged and displayed at the very beginning position in the right edge region at step S43, the message identification corresponding to the instant messenger B is highlighted, in order to accomplish more effective prompting. The time period for highlighting may be set in advance. For example, the highlighting lasts 2 seconds, 5 seconds, or any other preset period. In addition, the message identification may blink by being highlighted intermittently, and the number of blinks may also be set in advance. For example, the message identification blinks (is highlighted intermittently) three times.

At step S44, the message identification corresponding to the instant messenger is arranged and displayed in the right edge region.

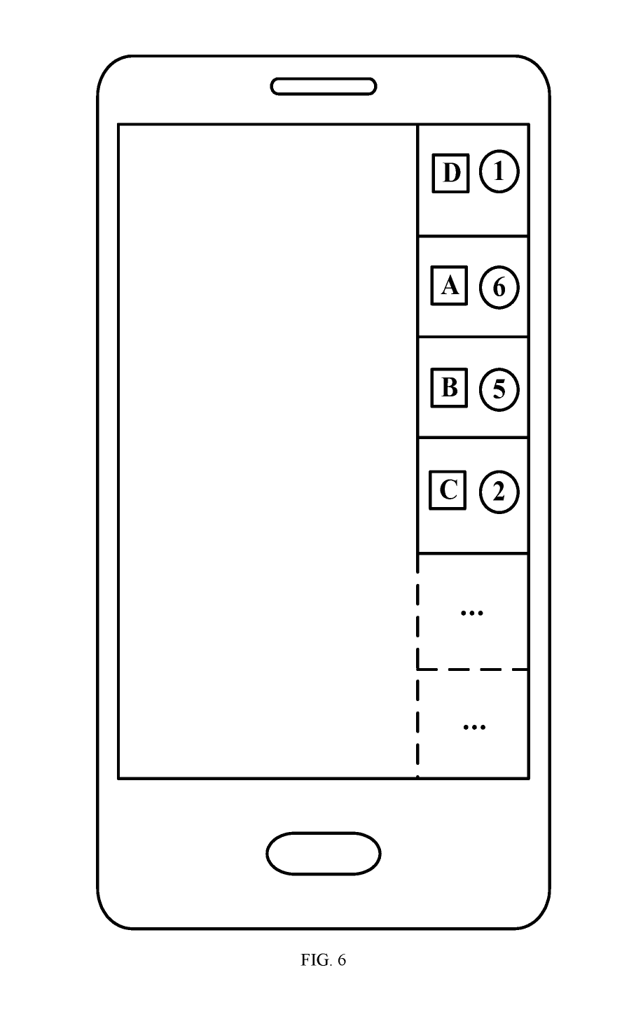

For example, if the instant messenger corresponding to the received instant message is an instant messenger D, then a message identification corresponding to the instant messenger D is displayed at the very beginning position in the right edge region. The message identification includes an application identification of the instant messenger D and the number of unprocessed instant messages received by the instant messenger D. As shown in FIG. 6, at this point, the number of unprocessed instant messages received by the instant messenger D is 1.

The embodiment illustrates the case where the predetermined edge region is the right edge region. The implementation for another predetermined edge region is the same as that for the right edge region and will not be described here redundantly.

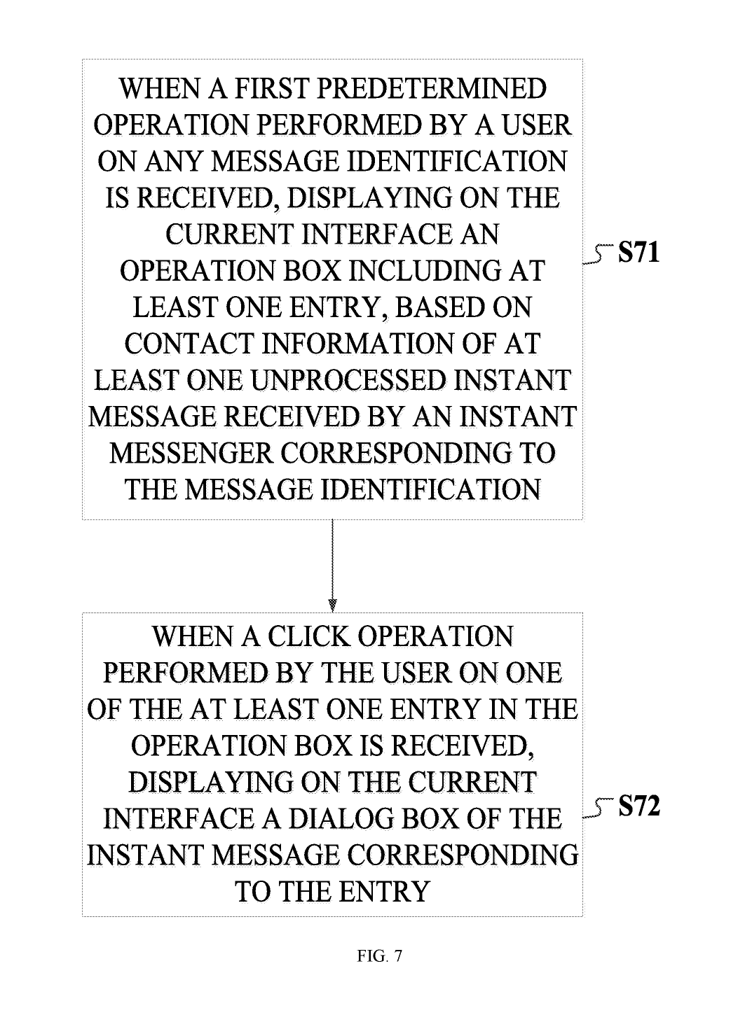

Further to the manner for displaying a message identification according to the above embodiment, the above method may also include steps S71-S72 shown in FIG. 7.

At step S71, when a first predetermined operation performed by a user on any message identification is received, an operation box including at least one entry is displayed on the current interface, based on contact information of at least one unprocessed instant message received by an instant messenger corresponding to the message identification. Each entry corresponds to at least one instant message sent by a contact.

After the user performs the first predetermined operation on the message identification, displaying of the message identification in the predetermined edge region may be cancelled.

The first predetermined operation includes at least one of the following: a predetermined number of click operations on the message identification; and a sliding operation of sliding the message identification along a predetermined direction. For example, after the user clicks the message identification once or multiple times consecutively or slides the message identification towards the center of the current interface of the terminal, an operation box corresponding to the message identification may be displayed on the current interface of the terminal. The operation box includes one or more entries, and has a size smaller than the current interface of the terminal.

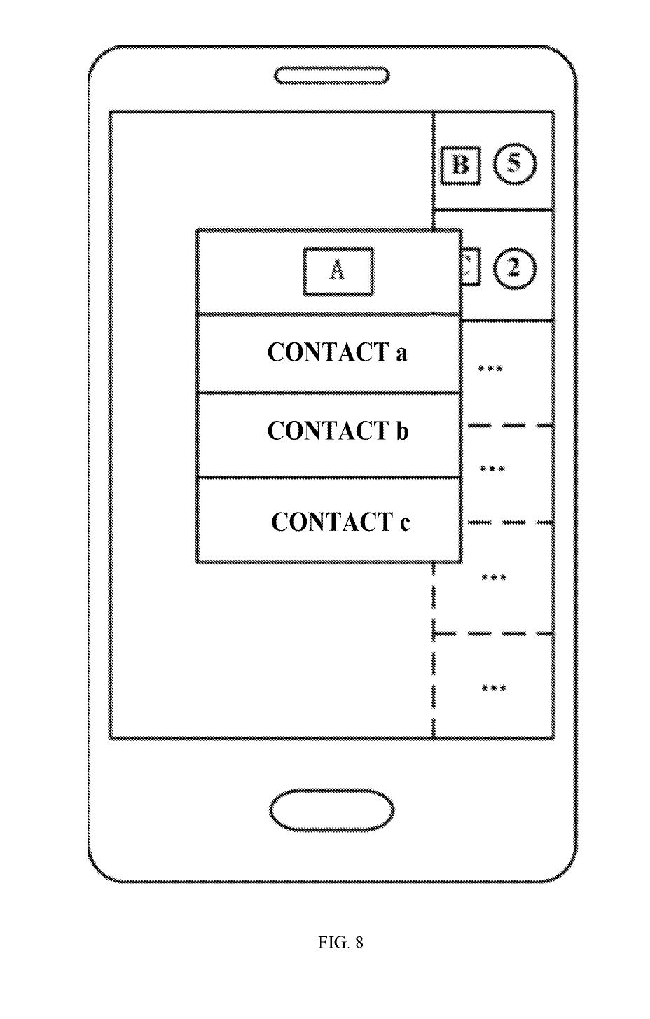

Taking again the technical solution according to the above one or more exemplary embodiments as an example, supposing contacts corresponding to unprocessed instant messages received by the instant messenger A include contacts a, b and c, an operation box including three entries will be displayed on the current interface of the terminal after the user performs the first predetermined operation on the message identification corresponding to the instant messenger A. The three entries correspond respectively to instant messages sent by the contacts a, b and c, as shown in FIG. 8.

In an embodiment, each entry in the operation box may also display the number of instant messages sent by the corresponding contact, so as to provide the user with more detailed information on the instant messages.

At step S72, when a click operation performed by the user on one of the at least one entry in the operation box is received, a dialog box of the instant message corresponding to the entry is displayed on the current interface. The dialog box has a size smaller than the current interface. For example, the size of the dialog box is half the size of the current interface. In addition, the dialog box may include contents of the instant message corresponding to the entry.

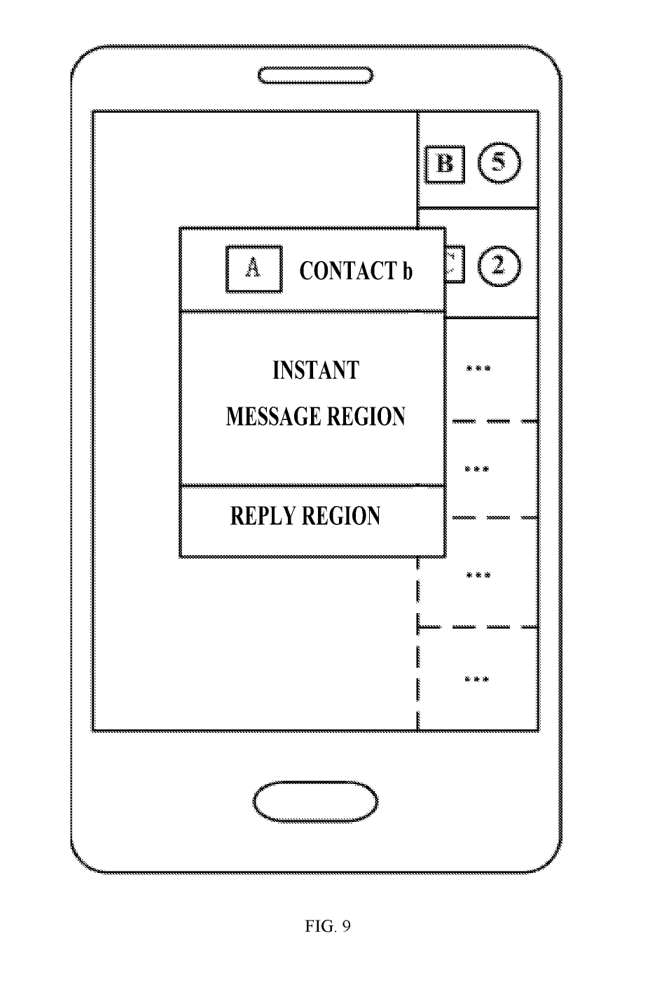

Taking the terminal interface shown in FIG. 8 as an example, when the user performs a click operation on the entry corresponding to the contact b, a dialog box of one or more instant messages corresponding to the entry will be displayed on the current interface. The user can directly process the instant messages sent by the contact b in the dialog box. As shown in FIG. 9, the dialog box has an “instant message region” for displaying instant messages communicated between the user and the contact b and a “reply region” for the user to reply to the instant messages. After the user clicks the “reply region,” a keyboard may be popped up on the current interface for the user to enter contents for replying.

Furthermore, for an operation box and/or a dialog box for instant messages displayed on the terminal, the user may cancel displaying of the operation box and/or the dialog box by performing a predetermined operation. For example, after the user completes processing of an instant message in the dialog box, he/she can cancel displaying of the dialog box on the current interface simply by sliding the dialog box towards the edge of the terminal. Then, if there is any other unprocessed instant message in the instant messenger corresponding to the instant message, the message identification corresponding to the instant messenger displayed in the predetermined edge region will be updated (for example, the number of instant messages will be updated). If all instant messages in the instant messenger corresponding to the instant message have been processed, the message identification corresponding to the instant message will not be displayed in the predetermined edge region any more.

In the embodiment, by displaying a dialog box of an instant message, the user can process the instant message in the dialog box without entering the interface of an instant messenger. Especially, when a terminal is displaying another application interface, the user can process an instant message in a dialog box and return to the other application interface after processing the instant message, thereby saving a large amount of time and eliminating cumbersome operations for the user to process the instant message and hence improving user experience.

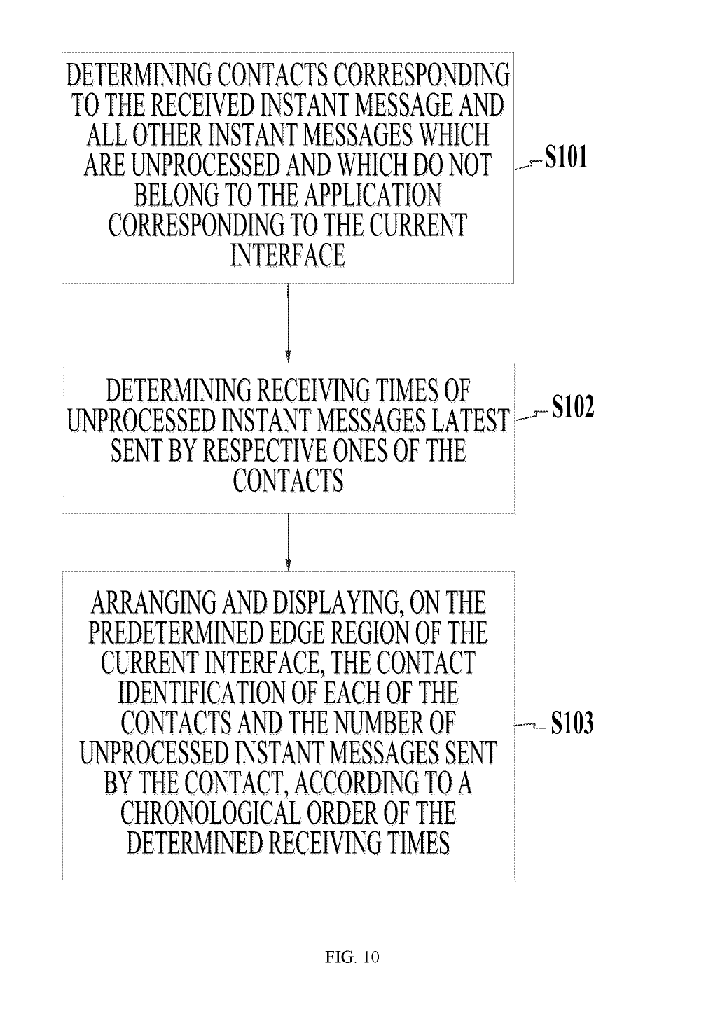

In an embodiment, the message identification may include only the identification of the contact sending the instant message or both the identification of the contact sending the instant message and the number of unprocessed instant messages sent by the contact sending the instant message. In the latter case, as shown in FIG. 10, the step S12 may be implemented as the following steps S101-S103.

At step S101, contacts corresponding to the received instant message and all other instant messages which are unprocessed and which do not belong to the application corresponding to the current interface are determined.

At step S102, receiving times of unprocessed instant messages latest sent by respective ones of the contacts are determined.

At step S103, the contact identification of each of the contacts and the number of unprocessed instant messages sent by the contact are arranged and displayed on the predetermined edge region of the current interface, according to a chronological order of the determined receiving times.

As can be seen from the embodiment, when the terminal receives a new instant message which does not belong to the application corresponding to the current interface, the terminal displays the message identification corresponding to the instant message at the very beginning position in the predetermined edge region.

In the embodiment, by arranging and displaying, on a predetermined edge region, contact identifications of contacts and the numbers of unprocessed instant messages sent by the contacts wherein message identifications are arranged and displayed according to receiving times of unprocessed instant messages latest sent by respective ones of the contacts, the user can know at a glance information on unprocessed instant messages (especially contact information of and the chronological order of the receiving times of the unprocessed instant messages) without entering interfaces of instant messengers corresponding to the instant messages, thereby improving user experience.

In the following, the technical solution according to the embodiment will be explained by giving a one or more exemplary embodiments.

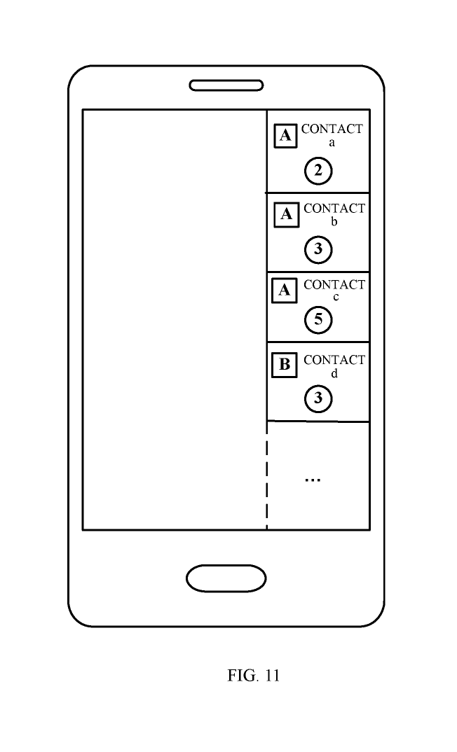

FIG. 11 is a diagram illustrating a current interface of a terminal in one or more embodiments. Here, the predetermined edge region is a right edge region of the current interface of the terminal. As shown in FIG. 11, the application corresponding to the current interface of the terminal is an application M. On the right edge region of the interface of the terminal, there are arranged and displayed message identifications of unprocessed instant messages sent by contacts a, b and c in an instant messenger A and a contact d in an instant messenger B. Each message identification includes an identification of its corresponding contact and the number of unprocessed instant messages sent by the contact.

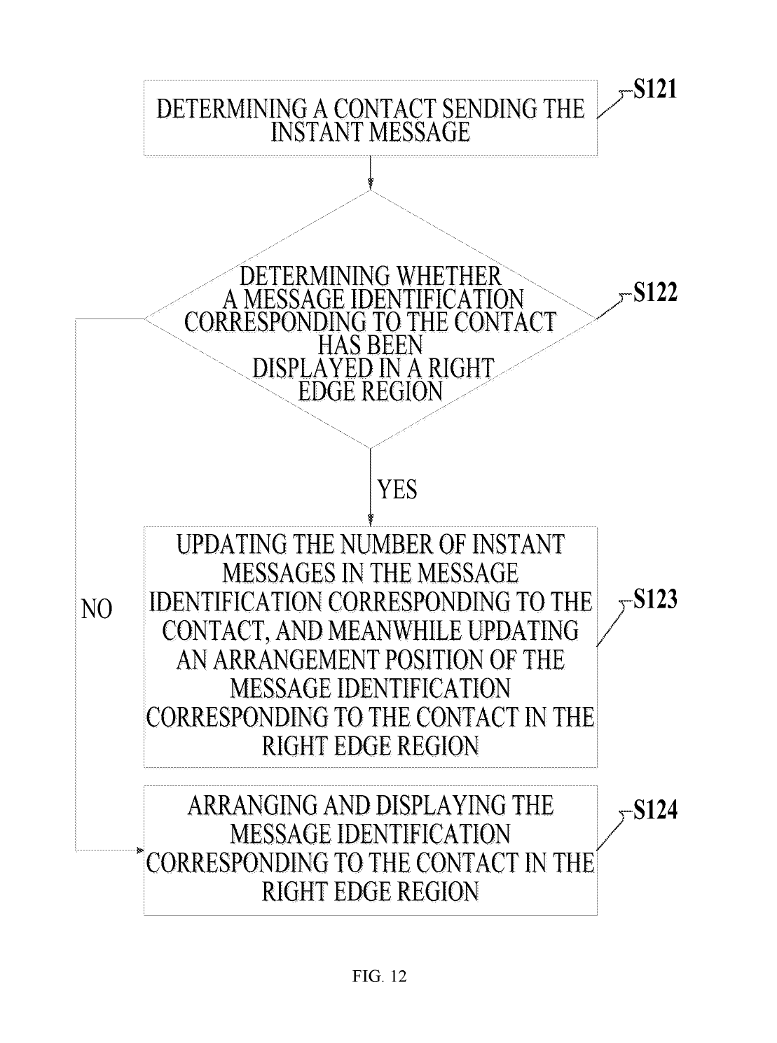

On the terminal interface shown in FIG. 11, the number of unprocessed instant messages sent by each contact is shown as a numerical value. Specifically, the number of unprocessed instant messages sent by the contact a in the instant messenger A is 2, the number of unprocessed instant messages sent by the contact b in the instant messenger A is 3, the number of unprocessed instant messages sent by the contact c in the instant messenger A is 5, and the number of unprocessed instant messages sent by the contact d in the instant messenger B is 3. When the terminal receives a further instant message which does not belong to the application corresponding to the current interface (namely, the application M), the message identification of the instant message may be arranged and displayed according to the following steps S121-S124 shown in FIG. 12, since the receiving time of the instant message is later than that of any instant message in the right edge region.

At step S121, a contact sending the instant message is determined.

At step S122, it is determined whether a message identification corresponding to the contact has been displayed in the right edge region. The message identification corresponding to the contact is a message identification of one or more unprocessed instant messages sent by the contact. If the message identification corresponding to the contact has been displayed in the right edge region, then step S123 is performed. If the message identification corresponding to the contact has not been displayed in the right edge region, step S124 is performed.

At step S123, the number of instant messages in the message identification corresponding to the contact is updated, and meanwhile an arrangement position of the message identification corresponding to the contact in the right edge region is updated.

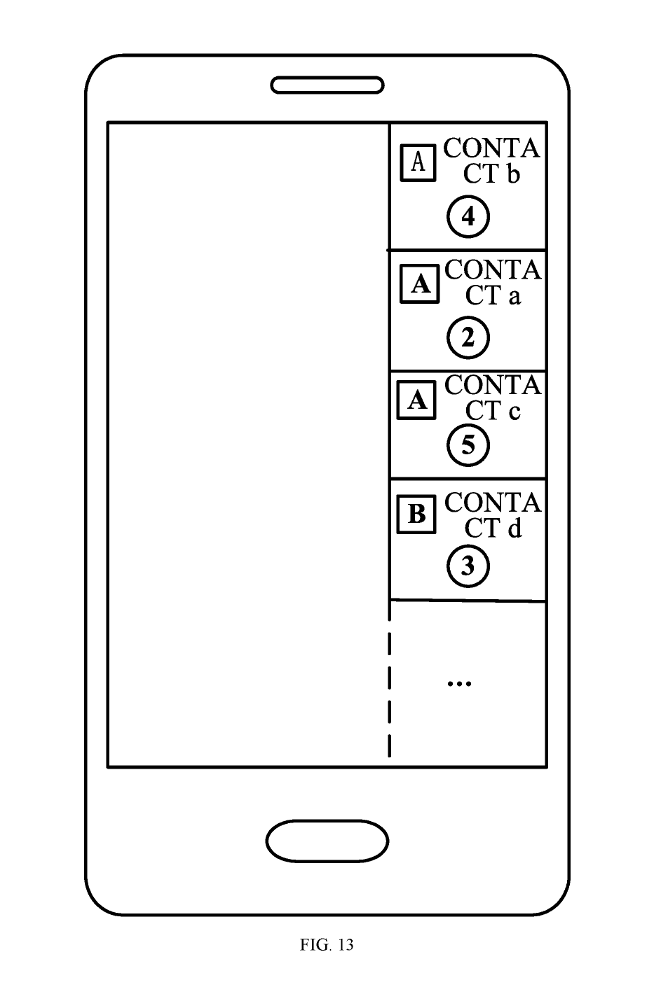

In the embodiment, the later the receiving time of the unprocessed instant message latest sent by the contact is, the nearer the arrangement position of the message identification corresponding to the contact is to the beginning position in the predetermined edge region. For example, if the contact sending the instant message is the contact b in the instant messenger A, then the number in the message identification corresponding to the contact b is updated from 3 to 4 and meanwhile the message identification corresponding to the contact b is displayed at the very beginning position in the right edge region, as shown in FIG. 13.

In addition, the message identification corresponding to the contact may also be displayed in a highlighted manner. For example, while being displayed at the very beginning position in the right edge region at step S123, the message identification corresponding to the contact b is highlighted, in order to accomplish more effective prompting. The time period for highlighting may be set in advance. For example, the highlighting lasts 5 seconds. In addition, the message identification may blink by being highlighted intermittently, and the number of blinks may also be set in advance. For example, the message identification blinks (is highlighted) three times.

At step S124, the message identification corresponding to the contact is arranged and displayed in the right edge region.

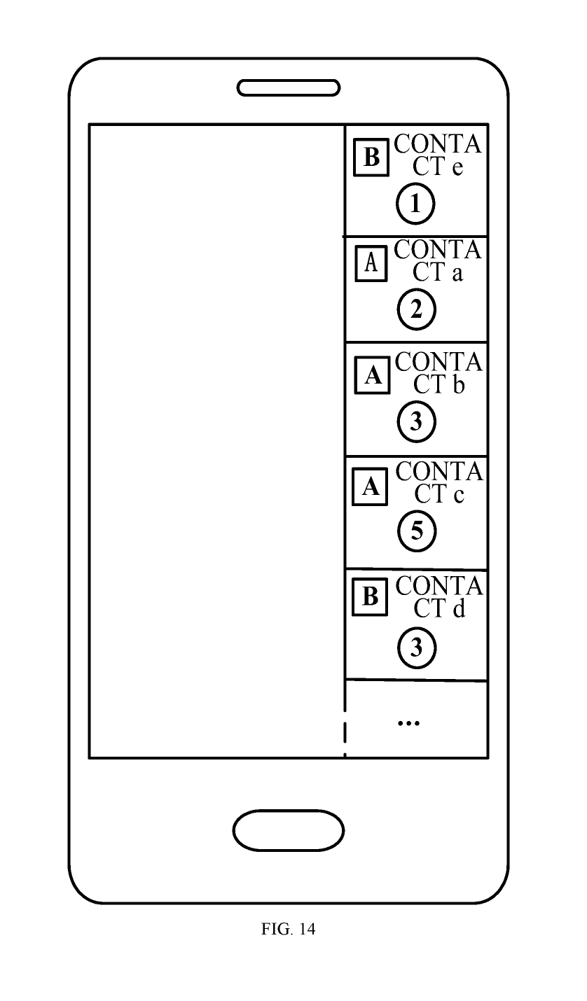

For example, if the contact sending the instant message is a contact e in the instant messenger B, then a message identification corresponding to the contact e is arranged and displayed at the very beginning position in the right edge region. The message identification includes a contact identification of the contact e and the number of unprocessed instant messages sent by the contact e. As shown in FIG. 14, at this point, the number of unprocessed instant messages sent by the contact e is 1.

The embodiment illustrates the case where the predetermined edge region is the right edge region. The implementation for another predetermined edge region is the same as that for the right edge region and will not be described here redundantly.

Further to the manner for displaying a message identification according to the above embodiment, the method further includes: when a second predetermined operation performed by a user on any message identification is received, a dialog box of at least one instant message sent by a contact corresponding to the message identification is displayed on the current interface. The dialog box has a smaller size than the current interface, and the dialog box may include contents of the instant message sent by the contact corresponding to the message identification.

After the dialog box including the instant message sent by the contact is displayed on the current interface, displaying of the message identification corresponding to the contact in the predetermined edge region may be cancelled.

The second predetermined operation may include at least one of the following: a predetermined number of click operations on the message identification; and a sliding operation of sliding the message identification along a predetermined direction. For example, after the user clicks the message identification once or twice consecutively or slides the message identification towards the center of the current interface of the terminal, a dialog box corresponding to the message identification will be displayed on the current interface of the terminal.

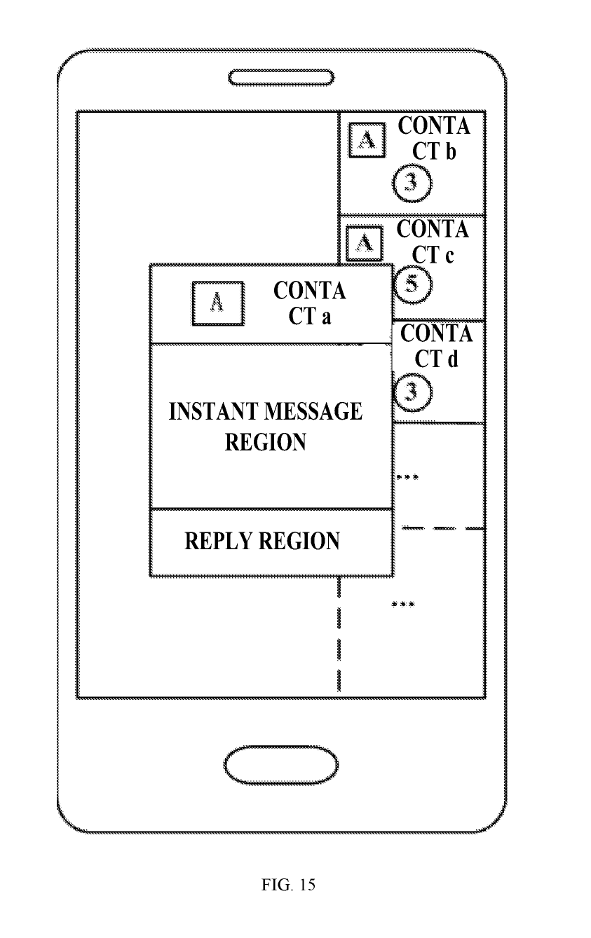

Taking again the technical solution according to the above one or more exemplary embodiments as an example, the second predetermined operation is sliding to the left. If the user slides the message identification corresponding to the contact a in the instant messenger A to the left on the current interface of the terminal shown in FIG. 11, a dialog box of instant messages sent by the contact a will be displayed on the current interface of the terminal. As shown in FIG. 15, the dialog box has a size smaller than the current interface. For example, the size of dialog box is half the size of the current interface. The dialog box has an “instant message region” for displaying instant messages communicated between the user and the contact a and a “reply region” for the user to reply to the instant messages. After the user clicks the “reply region,” a keyboard may be popped up for the user to enter contents for replying.

In the embodiment, by displaying a dialog box of an instant message, the user can process the instant message in the dialog box without entering the interface of an instant messenger. Especially, when a terminal is displaying another application interface, the user can process an instant message in a dialog box and return to the other application interface after processing the instant message, thereby saving a large amount of time and eliminating cumbersome operations for the user to process the instant message and hence improving user experience.

In an embodiment, for a dialog box for an instant message displayed on the terminal, the user may cancel displaying of the dialog box by performing a predetermined operation, so that the terminal returns to the application previously displayed on the interface. For example, when viewing another page, the user processes an instant message in a popped-up dialog box. After completing the processing, the user slides the dialog box towards the edge of the terminal, so that the terminal will return to the other page previously viewed by the user without requiring the user to perform cumbersome operations.

In any of the above embodiments, the user may cancel displaying of message identifications of instant messages by performing a predetermined operation. For example, it is set in advance not to display message identifications of instant messages; or after the message identifications of the instant messages are displayed, displaying of the message identifications of the instant messages is cancelled by long-pressing a predetermined position in the predetermined edge region.

In any of the above embodiments, the user may also cancel displaying of one or more of message identifications of instant messages. For example, when the user would not like to process one or more instant messages corresponding to a certain message identification, he/she may cancel displaying of the message identification by long-pressing or sliding outwards the message identification.

In the following are described apparatus embodiments of the disclosure which can implement the method embodiments of the disclosure.

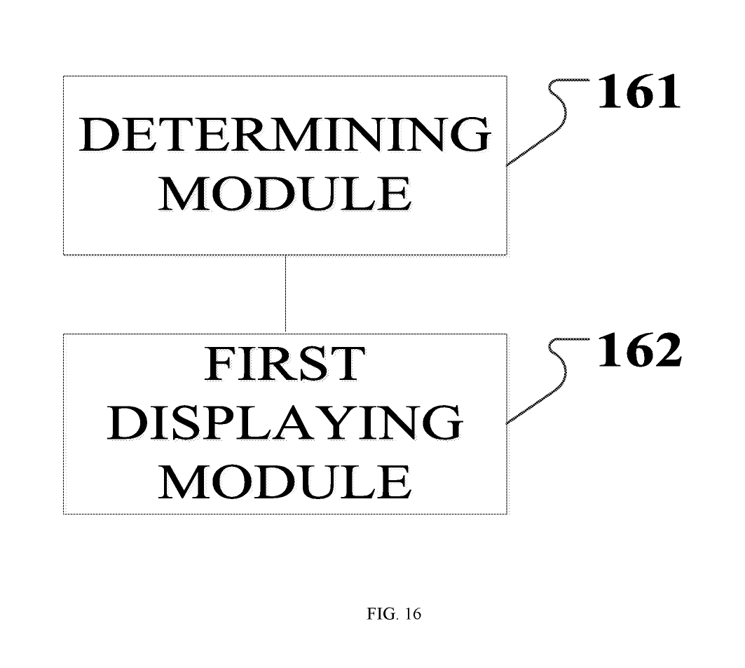

FIG. 16 is a block diagram of an instant message processing apparatus according to one or more exemplary embodiments. The apparatus may be implemented as a part or the entirety of an electronic device by software, hardware or a combination thereof. Referring to FIG. 16, the instant message processing apparatus comprises a determining module 161 and a first displaying module 162.

The determining module 161 is configured to receive an instant message and determine an instant messenger to which the instant message belongs.

The first displaying module 162 is configured to, when the determining module 161 determines that the instant messenger is not an application corresponding to a current interface, arrange and display, on a predetermined edge region of the current interface, the instant messenger together with all other instant messages which are unprocessed and which do not belong to the application corresponding to the current interface.

In one or more embodiments, the first displaying module 162 is configured to, when the received instant message is arranged and displayed, on the predetermined edge region of the current interface, together with all other instant messages which are unprocessed and which do not belong to the application corresponding to the current interface, display a message identification for each of the displayed instant messages. The message identification includes at least one of an application identification of an instant messenger corresponding to the instant message and an identification of a contact sending the instant message.

The predetermined edge region may be an edge region on one side of the current interface of the terminal, such as a left edge region, a right edge region, an upper edge region or a lower edge region on the current interface, so as not to block primary contents displayed on the current interface of the terminal from being seen.

With the apparatus according to the embodiment of the disclosure, after an instant message of an instant messenger other than an application corresponding to a current interface is received, it can be arranged and displayed by the first displaying module 162, on a predetermined edge region of the current interface, together with all other unprocessed instant messages of other instant messengers, thereby enabling a user to view, on the predetermined edge region of the current interface, all unprocessed instant messages of instant messengers other than the application corresponding to the current interface, and enabling a terminal to effectively prompt a user of instant messages of instant messengers while currently displaying another application interface and without affecting current display of the other application interface.

In an embodiment, the message identification displayed by the first displaying module 162 includes the application identification of the instant messenger corresponding to the instant message and a number of unprocessed instant messages received by the instant messenger corresponding to the instant message; or the message identification displayed by the first displaying module 162 includes the identification of the contact sending the instant message and a number of unprocessed instant messages sent by the contact sending the instant message.

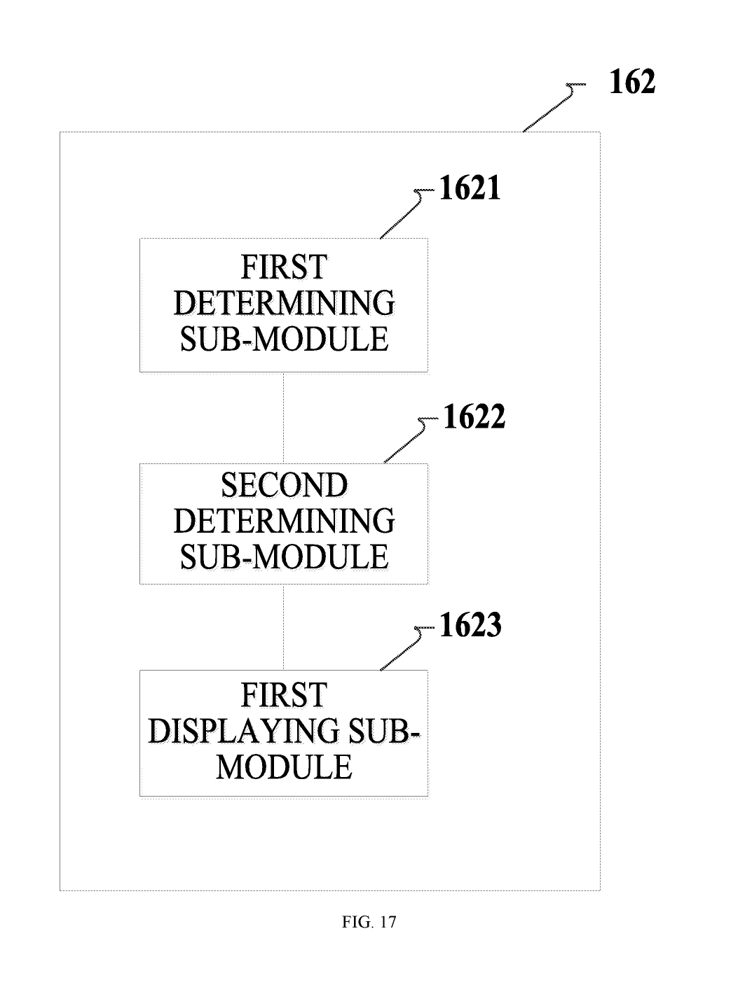

In an embodiment, as shown in FIG. 17, when the message identification includes the application identification of the instant messenger corresponding to the instant message and the number of unprocessed instant messages received by the instant messenger corresponding to the instant message, the first displaying module 162 comprises: a first determining sub-module 1621, a second determining sub-module 1622 and a first displaying sub-module 1623.

The first determining sub-module 1621 is configured to determine instant messengers corresponding to the received instant message and all other instant messages which are unprocessed and which do not belong to the application corresponding to the current interface

The second determining sub-module 1622 is configured to determine receiving times of unprocessed instant messages latest received by respective ones of the instant messengers determined by the first determining sub-module 1621.

The first displaying sub-module 1623 is configured to arrange and display, on the predetermined edge region of the current interface, the application identification of each of the instant messengers and the number of unprocessed instant messages received by the instant messenger, according to a chronological order of the receiving times determined by the second determining sub-module 1622.

As can be seen from this embodiment, when the terminal receives a new instant message which does not belong to the application corresponding to the current interface, it will display the message identification corresponding to the instant message at the very beginning position in the predetermined edge region.

In this embodiment, by arranging and displaying, by the first displaying sub-module 1623, application identifications of instant messengers and the numbers of unprocessed instant messages received by the instant messengers on a predetermined edge region, the user can know at a glance information on unprocessed instant messages (especially the number of the unprocessed instant messages) without entering interfaces of instant messengers corresponding to the instant messages, thereby improving user experience.

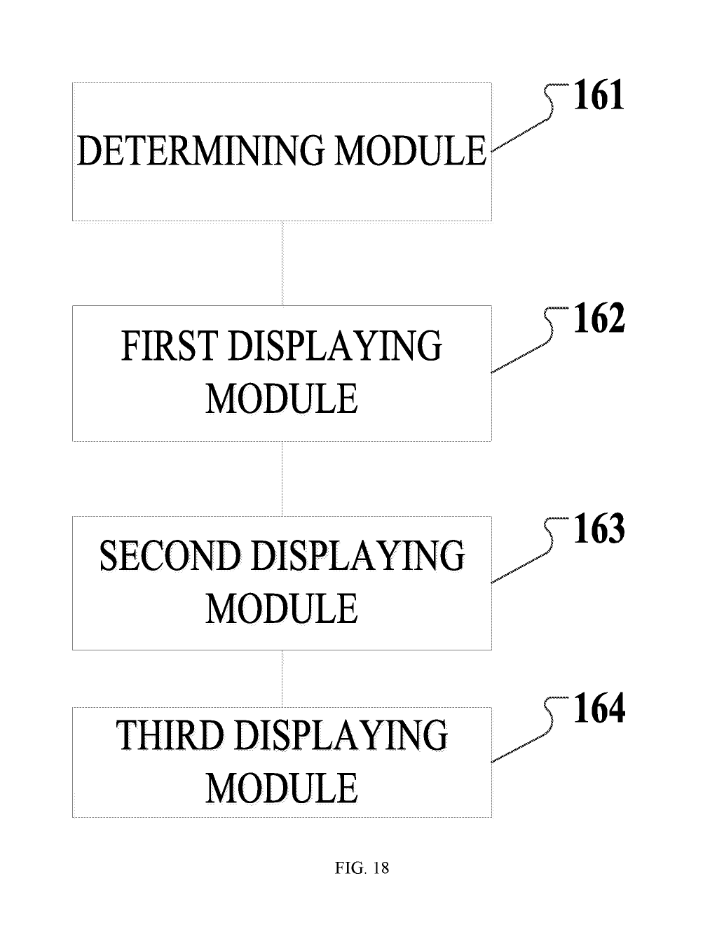

In an embodiment, as shown in FIG. 18, when the message identification displayed by the first displaying module 162 includes the application identification of the instant messenger corresponding to the instant message and the number of unprocessed instant messages received by the instant messenger corresponding to the instant message, the apparatus further comprises: a second displaying module 163 and a third displaying module 164.

The second displaying module 163 is configured to, when a first predetermined operation performed by a user on any message identification is received, display on the current interface an operation box including at least one entry, based on contact information of at least one unprocessed instant message received by an instant messenger corresponding to the message identification, wherein each entry corresponds to at least one instant message sent by one contact.

After the user performs the first predetermined operation on the message identification, displaying of the message identification in the predetermined edge region may be cancelled.

The first predetermined operation includes at least one of the following: a predetermined number of click operations on the message identification; and a sliding operation of sliding the message identification along a predetermined direction. For example, after the user clicks the message identification once or multiple times consecutively or slides the message identification towards the center of the current interface of the terminal, the second displaying module 163 will display an operation box corresponding to the message identification on the current interface of the terminal. The operation box includes one or more entries, and has a size smaller than the current interface of the terminal.

The third displaying module 164 is configured to, when a click operation performed by the user on one of the at least one entry in the operation box displayed by the second displaying module 163 is received, display on the current interface a dialog box of the instant message corresponding to the entry, wherein the dialog box has a smaller size than the current interface.

The dialog box has a size smaller than the current interface. For example, the size of the dialog box is half the size of the current interface. In addition, the dialog box may include contents of the instant message corresponding to the entry.

Furthermore, for an operation box and/or a dialog box for instant messages displayed on the terminal, the user may cancel displaying of the operation box and/or the dialog box by performing a predetermined operation. For example, after the user completes processing of an instant message in the dialog box, he/she can cancel displaying of the dialog box on the current interface simply by sliding the dialog box towards the edge of the terminal. Then, if there is any other unprocessed instant message in the instant messenger corresponding to the instant message, the message identification corresponding to the instant messenger displayed in the predetermined edge region will be updated (for example, the number of instant messages will be updated). If all instant messages in the instant messenger corresponding to the instant message have been processed, the message identification corresponding to the instant message will not be displayed in the predetermined edge region any more.

In the embodiment, by displaying a dialog box of an instant message by the third displaying module 164, the user can process the instant message in the dialog box without entering the interface of an instant messenger. Especially, when a terminal is displaying another application interface, the user can process an instant message in a dialog box and return to the other application interface after processing the instant message, thereby saving a large amount of time and eliminating cumbersome operations for the user to process the instant message and hence improving user experience.

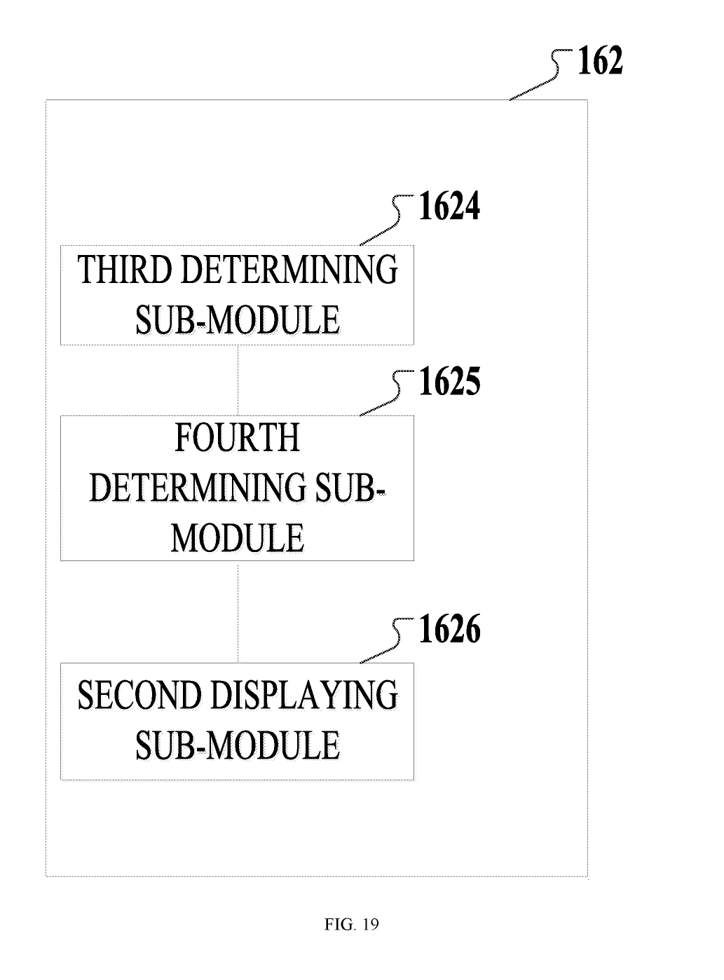

In an embodiment, as shown in FIG. 19, when the message identification includes the identification of the contact sending the instant message and the number of unprocessed instant messages sent by the contact sending the instant message, the first displaying module 162 comprises: a third determining sub-module 1624, a fourth determining sub-module 1625 and a second displaying sub-module 1626.

The third determining sub-module 1624 is configured to determine contacts corresponding to the received instant message and all other instant messages which are unprocessed and which do not belong to the application corresponding to the current interface.

The fourth determining sub-module 1625 is configured to determine receiving times of unprocessed instant messages latest sent by respective ones of the contacts determined by the third determining sub-module 1624.

The second displaying sub-module 1626 is configured to arrange and display, on the predetermined edge region of the current interface, the contact identification of each of the contacts and the number of unprocessed instant messages sent by the contact, according to a chronological order of the receiving times determined by the fourth determining sub-module 1625.

As can be seen from the embodiment, when the terminal receives a new instant message that does not belong to the application corresponding to the current interface, the terminal may display the message identification corresponding to the instant message at the very beginning position in the predetermined edge region.

In the embodiment, by arranging and displaying, by the second displaying sub-module 1626, contact identifications of contacts and the numbers of unprocessed instant messages sent by the contacts on a predetermined edge region, the user can know at a glance information on unprocessed instant messages (especially contact information of the unprocessed instant messages) without entering interfaces of instant messengers corresponding to the instant messages, thereby improving user experience.

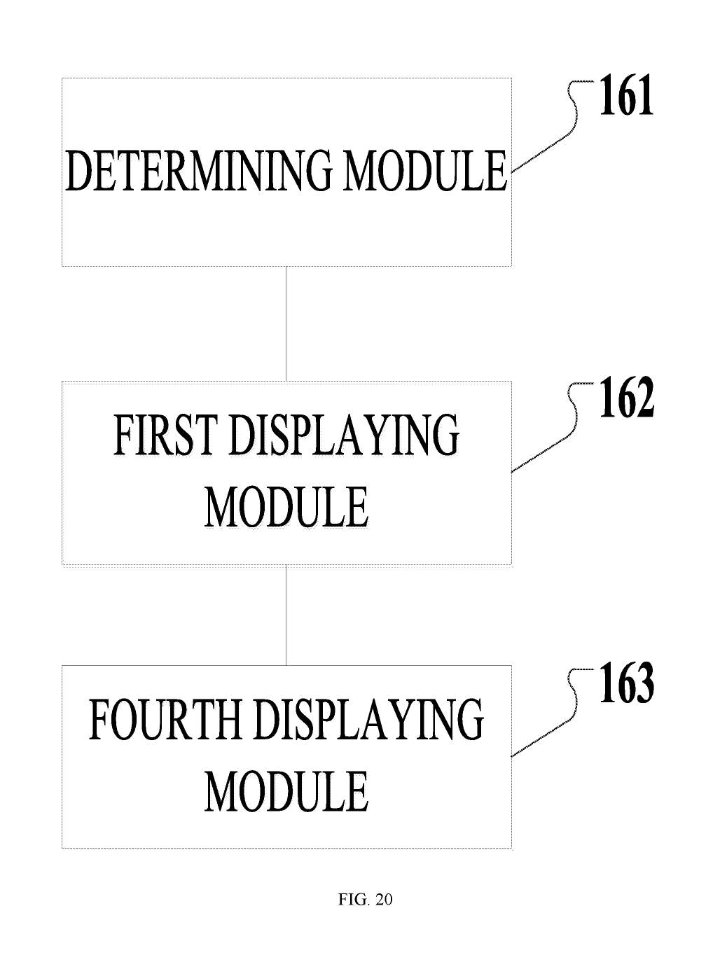

In an embodiment, as shown in FIG. 20, when the message identification displayed by the first displaying module 162 includes the identification of the contact sending the instant message and the number of unprocessed instant messages sent by the contact sending the instant message, the apparatus further includes a fourth displaying module 165. The fourth displaying module 165 is configured to, when a second predetermined operation performed by a user on any message identification is received, display on the current interface a dialog box of at least one instant message sent by a contact corresponding to the message identification.

The dialog box has a smaller size than the current interface, and the dialog box may include contents of the instant message sent by the contact corresponding to the message identification.

The second predetermined operation may include at least one of the following: a predetermined number of click operations on the message identification; and a sliding operation of sliding the message identification along a predetermined direction. For example, after the user clicks the message identification once or twice consecutively or slides the message identification towards the center of the current interface of the terminal, the fourth displaying module 165 will display a dialog box corresponding to the message identification on the current interface of the terminal.

In an embodiment, after the dialog box including the instant message sent by the contact is displayed on the current interface, displaying of the message identification corresponding to the contact in the predetermined edge region may be cancelled.

In the embodiment, by displaying a dialog box of an instant message by the fourth displaying module 165, the user may process the instant message in the dialog box without entering the interface of an instant messenger. Especially, when a terminal is displaying another application interface, the user can process an instant message in a dialog box and return to the other application interface after processing the instant message, thereby saving a large amount of time and eliminating cumbersome operations for the user to process the instant message and hence improving user experience.

In an embodiment, for a dialog box for an instant messages displayed on the terminal, the user may cancel displaying of the dialog box by performing a predetermined operation, so that the terminal returns to the application previously displayed on the interface. For example, when viewing another page, the user processes an instant message in a popped-up dialog box. After completing the processing, the user slides the dialog box towards the edge of the terminal, so that the terminal will return to the other page previously viewed by the user without requiring the user to perform cumbersome operations.

In any of the above embodiments, the user may cancel displaying of message identifications of instant messages by performing a predetermined operation. For example, it is set in advance not to display message identifications of instant messages; or after the message identifications of the instant messages are displayed, displaying of the message identifications of the instant messages is cancelled by long-pressing a predetermined position in the predetermined edge region.

In any of the above embodiments, the user may also cancel displaying of one or more of message identifications of instant messages. For example, when the user would not like to process one or more instant messages corresponding to a certain message identification, he/she may cancel displaying of the message identification by long-pressing or sliding outwards the message identification.

In one or more exemplary embodiments, there is provided an instant message processing apparatus, comprising a processor and a memory storing instructions executable by the processor. The processor is configured to: receive an instant message and determine an instant messenger to which the instant message belongs; and when it is determined that the instant messenger is not an application corresponding to a current interface, arrange and display, on a predetermined edge region of the current interface, the instant messenger together with all other instant messages which are unprocessed and which do not belong to the application corresponding to the current interface.

The processor may be further configured to, when the received instant message is arranged and displayed, on the predetermined edge region of the current interface, together with all other instant messages which are unprocessed and which do not belong to the application corresponding to the current interface, display a message identification for each of the displayed instant messages. The message identification includes at least one of an application identification of an instant messenger corresponding to the instant message and an identification of a contact sending the instant message.

The processor may be further configured such that: the message identification includes the application identification of the instant messenger corresponding to the instant message and a number of unprocessed instant messages received by the instant messenger corresponding to the instant message; or the message identification includes the identification of the contact sending the instant message and a number of unprocessed instant messages sent by the contact sending the instant message.

The processor may be further configured such that, when the message identification includes the application identification of the instant messenger corresponding to the instant message and the number of unprocessed instant messages received by the instant messenger corresponding to the instant message, arranging and displaying, on the predetermined edge region of the current interface, the received instant message together with all other instant messages which are unprocessed and which do not belong to the application corresponding to the current interface comprises: determining instant messengers corresponding to the received instant message and all other instant messages which are unprocessed and which do not belong to the application corresponding to the current interface; determining receiving times of unprocessed instant messages latest received by respective ones of the instant messengers; and arranging and displaying, on the predetermined edge region of the current interface, the application identification of each of the instant messengers and the number of unprocessed instant messages received by the instant messenger, according to a chronological order of the determined receiving times.

The processor may be further configured such that, when the message identification includes the application identification of the instant messenger corresponding to the instant message and the number of unprocessed instant messages received by the instant messenger corresponding to the instant message, the method further comprises: when a first predetermined operation performed by a user on any message identification is received, displaying on the current interface an operation box including at least one entry, based on contact information of at least one unprocessed instant message received by an instant messenger corresponding to the message identification, wherein each entry corresponds to at least one instant message sent by one contact; and when a click operation performed by the user on one of the at least one entry in the operation box is received, displaying on the current interface a dialog box of the instant message corresponding to the entry, wherein the dialog box has a smaller size than the current interface.

The processor may be further configured such that, when the message identification includes the identification of the contact sending the instant message and the number of unprocessed instant messages sent by the contact sending the instant message, arranging and displaying, on the predetermined edge region of the current interface, the received instant message together with all other instant messages which are unprocessed and which do not belong to the application corresponding to the current interface comprises: determining contacts corresponding to the received instant message and all other instant messages which are unprocessed and which do not belong to the application corresponding to the current interface; determining receiving times of unprocessed instant messages latest sent by respective ones of the contacts; and arranging and displaying, on the predetermined edge region of the current interface, the contact identification of each of the contacts and the number of unprocessed instant messages sent by the contact, according to a chronological order of the determined receiving times.

The processor may be further configured such that, when the message identification includes the identification of the contact sending the instant message and the number of unprocessed instant messages sent by the contact sending the instant message, the method further comprises: when a second predetermined operation performed by a user on any message identification is received, displaying on the current interface a dialog box of at least one instant message sent by a contact corresponding to the message identification, wherein the dialog box has a smaller size than the current interface.

The processor may be further configured such that the first predetermined operation or the second predetermined operation includes at least one of the following: a predetermined number of click operations on the message identification; and a sliding operation of sliding the message identification along a predetermined direction.

Regarding the apparatus in the above embodiments, the specific manners for the individual modules to perform operations have been described in detail in the embodiments of the related methods and will not be elaborated herein.

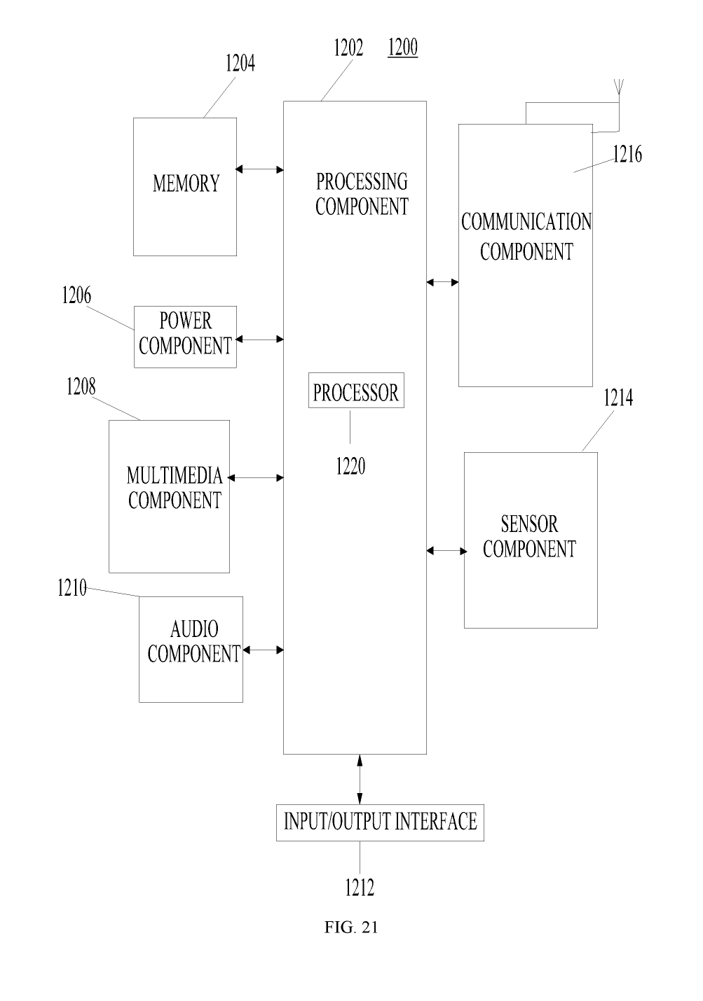

FIG. 21 is a block diagram of an instant message processing apparatus 1200 according to one or more exemplary embodiments. For example, the apparatus 1200 may be a mobile phone, a computer, a digital broadcast terminal, a messaging device, a gaming console, a tablet device, a medical device, exercise equipment, a personal digital assistant or the like.

The apparatus 1200 may comprise one or more of the following components: a processing component 1202, a memory 1204, a power component 1206, a multimedia component 1208, an audio component 1210, an input/output (I/O) interface 1212, a sensor component 1214 and a communication component 1216.

The processing component 1202 typically controls overall operations of the apparatus 1200, such as the operations associated with display, telephone calls, data communications, camera operations and recording operations. The processing component 1202 may include one or more processors 1220 to execute instructions to perform all or some of the steps in the above described methods. Moreover, the processing component 1202 may include one or more modules which facilitate the interaction between the processing component 1202 and other components. For example, the processing component 1202 may comprise a multimedia module to facilitate the interaction between the multimedia component 1208 and the processing component 1202.

The memory 1204 is configured to store various types of data to support the operation of the apparatus 1200. Examples of such data comprise instructions for any applications or methods operated on the apparatus 1200, contact data, phonebook data, messages, pictures, video, etc. The memory 1204 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may comprise a power management system, one or more power sources, and any other components associated with the generation, management, and distribution of power in the apparatus 1200.

The multimedia component 1208 comprises a screen providing an output interface between the apparatus 1200 and the user. In some embodiments, the screen may comprise a liquid crystal display (LCD) and a touch panel (TP). If the screen comprises the touch panel, the screen may be implemented as a touch screen to receive input signals from the user. The touch panel comprises one or more touch sensors to sense touches, swipes and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and the rear camera may receive an external multimedia datum while the apparatus 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (MIC) configured to receive an external audio signal when the apparatus 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 comprises one or more sensors to provide status assessments of various aspects of the apparatus 1200. For instance, the sensor component 1214 may detect an open/closed status of the apparatus 1200, relative positioning of components, e.g., the display and the keypad, of the apparatus 1200, a change in position of the apparatus 1200 or a component of the apparatus 1200, presence or absence of user's contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor or a temperature sensor.

The communication component 1216 is configured to facilitate communication, wired or wirelessly, between the apparatus 1200 and other devices. The apparatus 1200 can access a wireless network based on a communication standard, such as WiFi, 2Q or 3Q or a combination thereof. In one embodiment, the communication component 1216 receives a broadcast signal or broadcast associated information from an external broadcast management system via a broadcast channel. In one embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the apparatus 1200 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus 1200 may use the circuitries in combination with the other hardware or software components for performing the above described methods. Each module, sub-module, unit, or sub-unit in the disclosure may be implemented at least partially using the one or more circuitries.

In an embodiment, there is also provided a non-transitory computer-readable storage medium comprising instructions, such as comprised in the memory 1204, executable by the processor 1220 in the apparatus 1200, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein instructions that, when executed by the processor of the apparatus 1200, cause the apparatus 1200 to perform the above-described instant message processing method.

The method comprises: receiving an instant message and determining an instant messenger to which the instant message belongs; and when it is determined that the instant messenger is not an application corresponding to a current interface, arranging and displaying, on a predetermined edge region of the current interface, the instant messenger together with all other instant messages which are unprocessed and which do not belong to the application corresponding to the current interface.

When the received instant message is arranged and displayed, on the predetermined edge region of the current interface, together with all other instant messages which are unprocessed and which do not belong to the application corresponding to the current interface, a message identification is displayed for each of the displayed instant messages. The message identification includes at least one of an application identification of an instant messenger corresponding to the instant message and an identification of a contact sending the instant message.

The message identification includes the application identification of the instant messenger corresponding to the instant message and a number of unprocessed instant messages received by the instant messenger corresponding to the instant message; or the message identification includes the identification of the contact sending the instant message and a number of unprocessed instant messages sent by the contact sending the instant message.

When the message identification includes the application identification of the instant messenger corresponding to the instant message and the number of unprocessed instant messages received by the instant messenger corresponding to the instant message, arranging and displaying, on the predetermined edge region of the current interface, the received instant message together with all other instant messages which are unprocessed and which do not belong to the application corresponding to the current interface comprises: determining instant messengers corresponding to the received instant message and all other instant messages which are unprocessed and which do not belong to the application corresponding to the current interface; determining receiving times of unprocessed instant messages latest received by respective ones of the instant messengers; and arranging and displaying, on the predetermined edge region of the current interface, the application identification of each of the instant messengers and the number of unprocessed instant messages received by the instant messenger, according to a chronological order of the determined receiving times.

When the message identification includes the application identification of the instant messenger corresponding to the instant message and the number of unprocessed instant messages received by the instant messenger corresponding to the instant message, the method further comprises: when a first predetermined operation performed by a user on any message identification is received, displaying on the current interface an operation box including at least one entry, based on contact information of at least one unprocessed instant message received by an instant messenger corresponding to the message identification, wherein each entry corresponds to at least one instant message sent by one contact; and when a click operation performed by the user on one of the at least one entry in the operation box is received, displaying on the current interface a dialog box of the instant message corresponding to the entry, wherein the dialog box has a smaller size than the current interface.

When the message identification includes the identification of the contact sending the instant message and the number of unprocessed instant messages sent by the contact sending the instant message, arranging and displaying, on the predetermined edge region of the current interface, the received instant message together with all other instant messages which are unprocessed and which do not belong to the application corresponding to the current interface comprises: determining contacts corresponding to the received instant message and all other instant messages which are unprocessed and which do not belong to the application corresponding to the current interface; determining receiving times of unprocessed instant messages latest sent by respective ones of the contacts; and arranging and displaying, on the predetermined edge region of the current interface, the contact identification of each of the contacts and the number of unprocessed instant messages sent by the contact, according to a chronological order of the determined receiving times.

When the message identification includes the identification of the contact sending the instant message and the number of unprocessed instant messages sent by the contact sending the instant message, the method further comprises: when a second predetermined operation performed by a user on any message identification is received, displaying on the current interface a dialog box of at least one instant message sent by a contact corresponding to the message identification, wherein the dialog box has a smaller size than the current interface.

The first predetermined operation or the second predetermined operation includes at least one of the following: a predetermined number of click operations on the message identification; and a sliding operation of sliding the message identification along a predetermined direction.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for processing instant message, comprising:
receiving, by an apparatus, an instant message and determining an instant messenger to which the instant message belongs; and
when it is determined that the instant messenger is not an application corresponding to a current interface displayed on the apparatus, arranging and displaying, on a predetermined edge region of the current interface, the instant message together with one or more other unprocessed instant messages which do not belong to the application corresponding to the current interface.

2. The method of claim 1, further comprising:
when the received instant message is arranged and displayed, on the predetermined edge region of the current interface, together with one or more other unprocessed instant messages which do not belong to the application corresponding to the current interface, displaying a message identification for each of the displayed instant messages, wherein the message identification includes at least one of an application identification of the instant messenger corresponding to the instant message and an identification of a contact sending the instant message.

3. The method of claim 2, wherein the message identification includes the application identification of the instant messenger corresponding to the instant message and a number of unprocessed instant messages received by the instant messenger corresponding to the instant message; or
the message identification includes the identification of the contact sending the instant message and a number of unprocessed instant messages sent by the contact sending the instant message.

4. The method of claim 3, wherein
when the message identification includes the application identification of the instant messenger corresponding to the instant message and the number of unprocessed instant messages received by the instant messenger corresponding to the instant message, arranging and displaying, on the predetermined edge region of the current interface, the received instant message together with one or more other unprocessed instant messages which do not belong to the application corresponding to the current interface comprises:
determining instant messengers corresponding to the received instant message and one or more other unprocessed instant messages which do not belong to the application corresponding to the current interface;
determining receiving times of unprocessed instant messages latest received by respective ones of the instant messengers; and
arranging and displaying, on the predetermined edge region of the current interface, the application identification of each of the instant messengers and the number of unprocessed instant messages received by the instant messenger, according to a chronological order of the determined receiving times.

5. The method of claim 3, wherein
when the message identification includes the application identification of the instant messenger corresponding to the instant message and the number of unprocessed instant messages received by the instant messenger corresponding to the instant message, the method further comprises:
when a first predetermined operation on any message identification is received, displaying on the current interface an operation box including at least one entry, based on contact information of at least one unprocessed instant message received by the instant messenger corresponding to the message identification, wherein each entry corresponds to at least one instant message sent by one contact;
when a click operation performed by the user on one of the at least one entry in the operation box is received, displaying on the current interface a dialog box of the instant message corresponding to the entry, wherein the dialog box has a smaller size than the current interface.

6. The method of claim 3, wherein
when the message identification includes the identification of the contact sending the instant message and the number of unprocessed instant messages sent by the contact sending the instant message, arranging and displaying, on the predetermined edge region of the current interface, the received instant message together with one or more other unprocessed instant messages which do not belong to the application corresponding to the current interface comprises:
determining contacts corresponding to the received instant message and one or more other unprocessed instant messages which do not belong to the application corresponding to the current interface;
determining receiving times of unprocessed instant messages latest sent by respective ones of the contacts; and
arranging and displaying, on the predetermined edge region of the current interface, the contact identification of each of the contacts and the number of unprocessed instant messages sent by the contact, according to a chronological order of the determined receiving times.

7. The method of claim 3, wherein
when the message identification includes the identification of the contact sending the instant message and the number of unprocessed instant messages sent by the contact sending the instant message, the method further comprises:
when receiving a second predetermined operation on any message identification, displaying on the current interface a dialog box of at least one instant message sent by a contact corresponding to the message identification, wherein the dialog box has a smaller size than the current interface.

8. The method of claim 5, wherein the first predetermined operation or the second predetermined operation includes at least one of the following:
a predetermined number of click operations on the message identification;
a sliding operation of sliding the message identification along a predetermined direction.

9. The method of claim 7, wherein the first predetermined operation or the second predetermined operation includes at least one of the following:
a predetermined number of click operations on the message identification;
a sliding operation of sliding the message identification along a predetermined direction.

10. An apparatus, comprising:
a processor, and
a memory storing instructions executable by the processor,
wherein the processor is configured to:
receive an instant message and determine an instant messenger to which the instant message belongs; and
when it is determined that the instant messenger is not an application corresponding to a current interface, arrange and display, on a predetermined edge region of the current interface, the instant messenger together with one or more other unprocessed instant messages which do not belong to the application corresponding to the current interface.

11. The apparatus of claim 10, wherein
when the received instant message is arranged and displayed, on the predetermined edge region of the current interface, together with one or more other unprocessed instant messages which do not belong to the application corresponding to the current interface, a message identification is displayed for each of the displayed instant messages, wherein the message identification includes at least one of an application identification of an instant messenger corresponding to the instant message and an identification of a contact sending the instant message.

12. The apparatus of claim 11, wherein the message identification includes the application identification of the instant messenger corresponding to the instant message and a number of unprocessed instant messages received by the instant messenger corresponding to the instant message; or
the message identification includes the identification of the contact sending the instant message and a number of unprocessed instant messages sent by the contact sending the instant message.

13. The apparatus of claim 12, wherein
when the message identification includes the application identification of the instant messenger corresponding to the instant message and the number of unprocessed instant messages received by the instant messenger corresponding to the instant message, arranging and displaying, on the predetermined edge region of the current interface, the received instant message together with one or more other unprocessed instant messages which do not belong to the application corresponding to the current interface comprises:
determining instant messengers corresponding to the received instant message and one or more other unprocessed instant messages which do not belong to the application corresponding to the current interface;
determining receiving times of unprocessed instant messages latest received by respective ones of the instant messengers; and
arranging and displaying, on the predetermined edge region of the current interface, the application identification of each of the instant messengers and the number of unprocessed instant messages received by the instant messenger, according to a chronological order of the determined receiving times.

14. The apparatus of claim 12, wherein
when the message identification includes the application identification of the instant messenger corresponding to the instant message and the number of unprocessed instant messages received by the instant messenger corresponding to the instant message, the processor is further configured to:
when receiving a first predetermined operation on any message identification, display on the current interface an operation box including at least one entry, based on contact information of at least one unprocessed instant message received by an instant messenger corresponding to the message identification, wherein each entry corresponds to at least one instant message sent by one contact;
when a click operation performed by the user on one of the at least one entry in the operation box is received, display on the current interface a dialog box of the instant message corresponding to the entry, wherein the dialog box has a smaller size than the current interface.

15. The apparatus of claim 12, wherein
when the message identification includes the identification of the contact sending the instant message and the number of unprocessed instant messages sent by the contact sending the instant message, arranging and displaying, on the predetermined edge region of the current interface, the received instant message together with one or more other unprocessed instant messages which do not belong to the application corresponding to the current interface comprises:
determining contacts corresponding to the received instant message and one or more other unprocessed instant messages which do not belong to the application corresponding to the current interface;
determining receiving times of unprocessed instant messages latest sent by respective ones of the contacts; and
arranging and displaying, on the predetermined edge region of the current interface, the contact identification of each of the contacts and the number of unprocessed instant messages sent by the contact, according to a chronological order of the determined receiving times.

16. The apparatus of claim 12, wherein
when the message identification includes the identification of the contact sending the instant message and the number of unprocessed instant messages sent by the contact sending the instant message, the processor is further configured to:
when receiving a second predetermined operation on any message identification, display on the current interface a dialog box of at least one instant message sent by a contact corresponding to the message identification, wherein the dialog box has a smaller size than the current interface.

17. The apparatus of claim 14, wherein the first predetermined operation or the second predetermined operation includes at least one of the following:
a predetermined number of click operations on the message identification;
a sliding operation of sliding the message identification along a predetermined direction.

18. The apparatus of claim 16, wherein the first predetermined operation or the second predetermined operation includes at least one of the following:
a predetermined number of click operations on the message identification;
a sliding operation of sliding the message identification along a predetermined direction.

19. A non-transitory computer-readable storage medium having stored therein instructions that, when executed by a processor of a mobile terminal, cause the mobile terminal to perform acts comprising:
receiving an instant message and determining an instant messenger to which the instant message belongs; and
when it is determined that the instant messenger is not an application corresponding to a current interface, arranging and displaying, on a predetermined edge region of the current interface, the instant messenger together with one or more other unprocessed instant messages which do not belong to the application corresponding to the current interface.

20. The storage medium of claim 19, wherein
when the received instant message is arranged and displayed, on the predetermined edge region of the current interface, together with one or more other unprocessed instant messages which do not belong to the application corresponding to the current interface, a message identification is displayed for each of the displayed instant messages, wherein the message identification includes at least one of an application identification of an instant messenger corresponding to the instant message and an identification of a contact sending the instant message.
